(19) United States
(12) Patent Application Publication
(10) Pub. No.: US 2012/0154779 A1
(43) Pub. Date: Jun. 21, 2012

(54) SPECTRAL PURITY FILTER, LITHOGRAPHIC APPARATUS, AND METHOD FOR MANUFACTURING A SPECTRAL PURITY FILTER

(75) Inventors: Wouter Anthon Soer, Nijmegen (NL); Martin Jacobus Johan Jak, Eindhoven (NL)

(73) Assignee: ASML NETHERLANDS B.V., Veldhoven (NL)

(21) Appl. No.: 13/392,444

(22) PCT Filed: Jul. 16, 2010
(86) PCT No.: PCT/EP10/60295

§ 371 Date: Feb. 24, 2012

Related U.S. Application Data
(60) Provisional application No. 61/237,614, filed on Aug. 27, 2009.

(51) Int. Cl. G03B 27/72; B29D 11/00; G02B 5/28

(52) U.S. Cl. 355/71; 359/568; 216/24

(57) ABSTRACT

A method for manufacturing a spectral purity filter is provided in which openings in a first surface of a base material, corresponding to a plurality of apertures of the spectral purity filter, are formed. At least the surfaces of the base material surrounding the openings in the first surface are chemically treated to form a layer of a second material, and the base material is etched from the second surface such that the openings extend from the first surface of the base material to the second surface of the base material.

### CROSS-REFERENCE TO RELATED APPLICATIONS

This application claims the benefit of U.S. provisional application 61/237,614, which was filed on Aug. 27, 2009, and which is incorporated herein in its entirety by reference.

### FIELD

The present invention relates to spectral purity filters, lithographic apparatus including such spectral purity filters, and methods for manufacturing spectral purity filters.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

A key factor limiting pattern printing is the wavelength λ of the radiation used. In order to be able to project ever smaller structures onto substrates, it has been proposed to use extreme ultraviolet (EUV) radiation which is electromagnetic radiation having a wavelength within the range of 10-20 nm, for example within the range of 13-14 nm. It has further been proposed that EUV radiation with a wavelength of less than 10 nm could be used, for example within the range of 5-10 nm such as 6.7 nm or 6.8 nm. Such EUV radiation is sometimes termed soft x-ray. Possible sources include, for example, laser-produced plasma sources, discharge plasma sources, or synchrotron radiation from electron storage rings.

EUV sources based on a tin (Sn) plasma do not only emit the desired in-band EUV radiation but also out-of-band radiation, most notably in the deep UV (DUV) range (100-400 nm). Moreover, in the case of Laser Produced Plasma (LPP) EUV sources, the infrared radiation from the laser, usually at 10.6 μm, may present a significant amount of unwanted radiation. Since the optics of the EUV lithographic system generally have substantial reflectivity at these wavelengths, the unwanted radiation propagates into the lithography tool with significant power if no measures are taken.

In a lithographic apparatus, out-of-band radiation should be minimized for several reasons. Firstly, resist is sensitive to out-of-band wavelengths, and thus the image quality may be deteriorated. Secondly, unwanted radiation, especially the 10.6 μm radiation in LPP sources, leads to unwanted heating of the mask, wafer and optics. In order to bring unwanted radiation within specified limits, spectral purity filters (SPFs) are being developed. Spectral purity filters can be either reflective or transmissive for EUV radiation. Implementation of a reflective SPF typically requires modification of an existing mirror or insertion of an additional reflective element. A transmissive SPF is typically placed between the collector and the illuminator and, in principle at least, does not affect the radiation path. This may be an advantage because it results in flexibility and compatibility with other SPFs.

Grid SPFs form a class of transmissive SPFs that may be used when the unwanted radiation has a much larger wavelength than the EUV radiation, for example in the case of 10.6 μm radiation in LPP sources. Grid SPFs contain apertures with a size of the order of the wavelength to be suppressed. The suppression mechanism may vary among different types of grid SPFs as described in the prior art and detailed embodiments further in this document. Since the wavelength of EUV radiation (13.5 nm) is much smaller than the size of the apertures (typically >3 μm), EUV radiation is transmitted through the apertures without substantial diffraction.

Several prior art spectral purity filters (SPFs) rely on a grid with micron-sized apertures to suppress unwanted radiation. U.S. Patent Application Publication 2006/0146413 discloses a spectral purity filter (SPF) comprising an array of apertures with diameters up to 20 μm. Depending on the size of the apertures compared to the radiation wavelength, the SPF may suppress unwanted radiation by different mechanisms. If the aperture size is smaller than approximately half of the (unwanted) wavelength, the SPF reflects virtually all radiation of this wavelength. If the aperture size is larger, but still of the order of the wavelength, the radiation is at least partially diffracted and may be absorbed in a waveguide inside the aperture.

The approximate material parameters and specifications for these SPFs are known. However, manufacturing is not straightforward at these specifications. The most challenging specifications are: apertures of typically 4 μm in diameter; a grid thickness of typically 5-10 μm; very thin (typically <1 μm) and parallel (non-tapered) walls between the apertures to ensure maximal EUV transmission.

Silicon has emerged as a promising material for the manufacture of such grids, using the photolithographic patterning and anisotropic etching processes that are well understood from semiconductor manufacturing. For deep apertures with a well-controlled cross-section, deep reactive ion etching (DRIE) has been found to be promising, although difficulties remain in providing a method of manufacturing an EUV spectral purity filter with the required specifications.

### SUMMARY

It is an aspect of the present invention to provide a method of manufacturing an EUV spectral purity filter that is relatively simple to implement and provides an EUV spectral purity filter with the desired specifications.

According to an aspect of the invention, there is provided a method of manufacturing a spectral purity filter having a plurality of apertures configured to transmit extreme ultraviolet radiation and to suppress transmission of a second type of radiation, the method comprising: providing a base material, such as monocrystalline silicon, having first and second major surfaces; forming openings in the first surface of said base material corresponding to the required apertures of the spectral purity filter; chemically treating at least the surfaces of the base material surrounding the openings in the first surface to form a layer of a second material, different from the base material and which has greater resistance to an etching process than untreated base material; and etching the base material using said etching process in order to reduce the thickness of the base material at least in the region of the openings such that the openings extend through the base material.

Chemically treating the surfaces of the base material to form the second material may be arranged such that at least a layer of the base material on every surface of the base material is converted to the second material. Optionally, etching the base material comprises etching using potassium hydroxide and chemically treating the surfaces of the base material results in a second material with a greater resistance to etching with potassium hydroxide than the untreated base material. The base material may be etched from the second surface. Chemically treating the surfaces of the base material may be arranged such that substantially all of the base material between adjacent openings formed in the first surface of the base material is converted to the second material. Forming openings in the first surface of said base material may comprise deep reactive-ion etching. The method of manufacturing a spectral purity filter optionally includes selectively removing any of the second material formed on an end surface of the openings that is furthest away from the first surface including, for instance, by way of reactive-ion etching.

The step of etching the base material may reduce the thickness of the base material around the openings to a range of between 2 μm and 10 μm. The openings may be formed such that the width of material separating adjacent openings is less than 1 μm. A ratio of the resulting thickness of the base material in the region of the openings to the width of material separating adjacent openings may be in a range of between 5:1 and 20:1. The method may further include coating at least one of the first and second surfaces of the base material around the openings with a material, such as a metal, that is reflective to the second type of radiation.

According to an aspect of the invention there is provided a spectral purity filter manufactured according to the method above.

According to an aspect of the invention there is provided a spectral purity filter including a grid having a plurality of apertures configured to transmit extreme ultraviolet radiation and to suppress transmission of a second type of radiation, the grid further comprising walls separating the apertures from each other, wherein the walls are substantially formed from a silicon compound, such as silicon nitride.

According to an aspect of the invention there is provided a radiation source and a lithographic apparatus comprising a spectral purity filter manufactured according to the above method.

According to an aspect of the invention, there is provided a radiation source that includes a spectral purity filter that includes a grid comprising a plurality of apertures configured to transmit extreme ultraviolet radiation and to suppress transmission of a second type of radiation, and walls separating the apertures from each other, wherein the walls are substantially formed from a silicon compound

According to an aspect of the invention, there is provided a lithographic apparatus that includes a radiation source configured to generate radiation comprising extreme ultraviolet radiation and a second type of radiation and a spectral purity filter configured to transmit the extreme ultraviolet radiation and to suppress transmission of the second type of radiation. The spectral purity filter includes a grid comprising a plurality of apertures configured to transmit the extreme ultraviolet radiation and to suppress transmission of the second type of radiation, and walls separating the apertures from each other, wherein the walls are substantially formed from a silicon compound. The apparatus also includes a support configured to support a patterning device, the patterning device being configured to pattern the extreme ultraviolet radiation transmitted by the grid, and a projection system configured to project the patterned radiation onto a substrate.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts the layout of a lithographic apparatus according to an embodiment of the present invention;

FIG. 3 depicts a front view of a spectral purity filter according to an embodiment of the present invention;

FIG. 4 depicts a detail of a variation of a spectral purity filter according to an embodiment of the present invention;

FIG. 5 depicts a micrographic image of a tilted cross-section of a spectral purity filter at an intermediate stage of manufacture in accordance with an embodiment of the present invention;

FIG. 6 depicts a more detailed image of the wall between two apertures in the spectral purity filter of FIG. 5;

FIGS. 7 to 13 depict stages in the manufacture of a spectral purity filter according to a embodiment of the present invention;

FIG. 14 depicts a step of a process for manufacturing a spectral purity filter that is a variation of the method depicted in FIGS. 7 to 13; and

FIG. 15 depicts a step of a process for manufacturing a spectral purity filter that is a variation of the method depicted in FIGS. 7 to 13.

### DETAILED DESCRIPTION

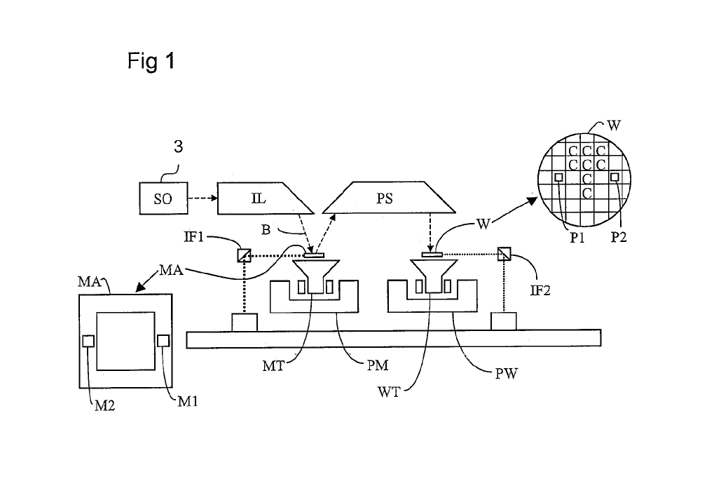

FIG. 1 schematically depicts a lithographic apparatus according to an embodiment of the invention. The apparatus comprises: an illumination system (illuminator) IL configured to condition a radiation beam B (e.g. UV radiation or EUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure supports, i.e. bears the weight of, the patterning device. It holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Present proposals for EUV lithography employ reflective patterning devices as shown in FIG. 1. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum.

Any use of the term “projection lens” herein may be considered as synonymous with the more general term “projection system”. For EUV wavelengths, transmissive materials are not readily available. Therefore “lenses” for illumination and projection in an EUV system will generally be of the reflective type, that is to say, curved mirrors.

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g. water, so as to fill a space between the projection system and the substrate. An immersion liquid may also be applied to other spaces in the lithographic apparatus, for example, between the mask and the projection system Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system comprising, for example, suitable directing mirrors and/or a beam expander. In other cases the source may be an integral part of the lithographic apparatus, for example when the source is a mercury lamp. The source SO and the illuminator IL, together with the beam delivery system if required, may be referred to as a radiation system.

The illuminator IL may comprise an adjusting device (adjuster) configured to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator and a condenser. The illuminator may be used to condition the radiation beam, to have a desired uniformity and intensity distribution in its cross-section.

The radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the mask MA with respect to the path of the radiation beam B, e.g. after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable minor array of a type as referred to above.

Combinations and/or variations on the above described modes of use or entirely different modes of use may also be employed.

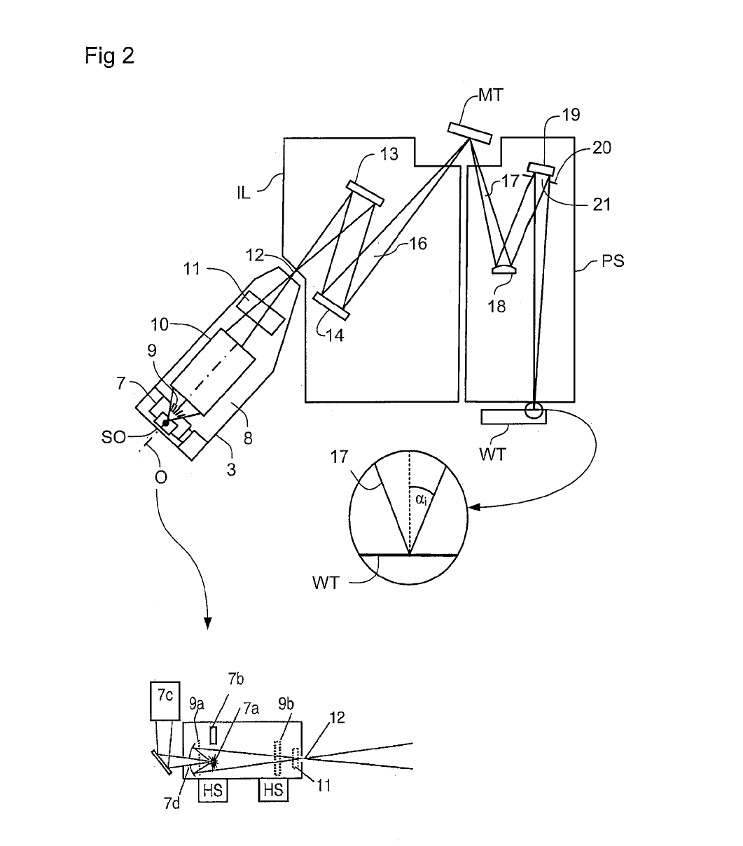

FIG. 2 depicts a schematic side view of a practical EUV lithographic apparatus. It will be noted that, although the physical arrangement is different to that of the apparatus shown in FIG. 1, the principle of operation is similar. The apparatus includes a source-collector-module or radiation unit 3, an illumination system IL and a projection system PS. Radiation unit 3 is provided with a radiation source 7, SO which may employ a gas or vapor, such as for example Xe gas or a vapor of Li, Gd or Sn in which a very hot discharge plasma is created so as to emit radiation in the EUV range of the electromagnetic radiation spectrum. The discharge plasma is created by causing a partially ionized plasma of an electrical discharge to collapse onto the optical axis O. Partial pressures of, for example, 10 Pa 0.1 mbar of Xe, Li, Gd, Sn vapor or any other suitable gas or vapor may be desired for efficient generation of the radiation. In an embodiment, a Sn source as EUV source is applied.

The main part of FIG. 2 illustrates radiation source 7 in the form of a discharge-produced plasma (DPP). The alternative detail at lower left in the drawing illustrates an alternative form of source, using a laser-produced plasma (LPP). In the LPP type of source, an ignition region 7a is supplied with plasma fuel, for example droplets of molten Sn, from a fuel delivery system 7b. A laser beam generator 7c and associated optical system deliver a beam of radiation to the ignition region. Generator 7c may be a CO₂ laser having an infrared wavelength, for example 10.6 micrometer or 9.4 micrometer. Alternatively, other suitable lasers may be used, for example having respective wavelengths in the range of 1-11 micrometers. Upon interaction with the laser beam, the fuel droplets are transferred into plasma state which may emit, for example, 6.7 nm radiation, or any other EUV radiation selected from the range of 5-20 nm. EUV is the example of concern here, though a different type of radiation may be generated in other applications. The radiation generated in the plasma is gathered by an elliptical or other suitable collector 7d to generate the source radiation beam having intermediate focus 12.

Returning to the main part of FIG. 2, the radiation emitted by radiation source SO is passed from the DPP source chamber 7 into collector chamber 8 via a contaminant trap 9 in the form of a gas barrier or “foil trap”. This will be described further below. Collector chamber 8 may include a radiation collector 10 which is, for example, a grazing incidence collector comprising a nested array of so-called grazing incidence reflectors. Radiation collectors suitable for this purpose are known from the prior art. The beam of EUV radiation emanating from the collector 10 will have a certain angular spread, perhaps as much as 10 degrees either side of optical axis O. In the LPP source shown at lower left, a normal incidence collector 7d is provided for collecting the radiation from the source.

Radiation passed by collector 10 transmits through a spectral purity filter 11 according to embodiments of the present invention. It should be noted that in contrast to reflective grating spectral purity filters, the transmissive spectral purity filter 11 does not change the direction of the radiation beam. Embodiments of the filter 11 are described below. The radiation is focused in a virtual source point 12 (i.e. an intermediate focus) from an aperture in the collection chamber 8. From chamber 8, the radiation beam 16 is reflected in illumination system IL via normal incidence reflectors 13,14 onto a reticle or mask positioned on reticle or mask table MT. A patterned beam 17 is formed which is imaged by projection system PS via reflective elements 18,19 onto wafer W mounted wafer stage or substrate table WT. More elements than shown may generally be present in the illumination system IL and projection system PS. One of the reflective elements 19 has in front of it an NA disc 20 having an aperture 21 there-through. The size of the aperture 21 determines the angle αᵢ subtended by the patterned radiation beam 17 as it strikes the substrate table WT.

FIG. 2 shows the spectral purity filter 11 positioned closely upstream of the virtual source point 12. In alternative embodiments, not shown, the spectral purity filter 11 may be positioned at the virtual source point 12 or at any point between the collector 10 and the virtual source point 12. The filter can be placed at other locations in the radiation path, for example downstream of the virtual source point 12. Multiple filters can be deployed.

The gas barrier may include a channel structure such as, for instance, described in detail in U.S. Pat. Nos. 6,614,505 and 6,359,969, which are incorporated herein by reference. The purpose of this contaminant trap is to prevent or at least reduce the incidence of fuel material or by-products impinging on the elements of the optical system and degrading their performance over time. These elements include the collector 10 and the spectral purity filter 11. In the case of the LPP source shown in detail at bottom left of FIG. 2, the contaminant trap may include a first trap arrangement 9a which protects the elliptical collector 7d, and optionally further trap arrangements, such as shown at 9b. The gas barrier may act as a physical barrier (by fluid counter-flow), by chemical interaction with contaminants and/or by electrostatic or electromaguetic deflection of charged particles. In practice, a combination of these methods are employed to permit transfer of the radiation into the illumination system, while blocking the plasma material to the greatest extent possible. As explained in the above-mentioned United States patents, hydrogen radicals in particular may be injected for chemically modifying the Sn or other plasma materials.

Hydrogen radicals can also be applied for cleaning of Sn and other contaminants which may already be deposited on the optical surfaces. Further, hydrogen gas may be deployed in the vicinity of the wafer support WT, as a buffer against contaminants from the wafer entering the larger vacuum spaces within the system. In a vacuum environment, typical photoresist materials, not to mention components of the supports and positioning systems, tend to release organic and other gaseous materials which could contaminate the optical components over time.

For all these purposes, hydrogen sources HS are shown deployed for the supplying hydrogen gas to each contaminant trap arrangement 9a, 9b, and at ports to the chambers of the illumination system IL and projection system PS. Some sources may supply molecular hydrogen gas (H₂) as a simple buffer while others generate H radicals. The molecular hydrogen which permeates the vacuum environment can become radicalized by radiation, electric discharge and so forth in the environment.

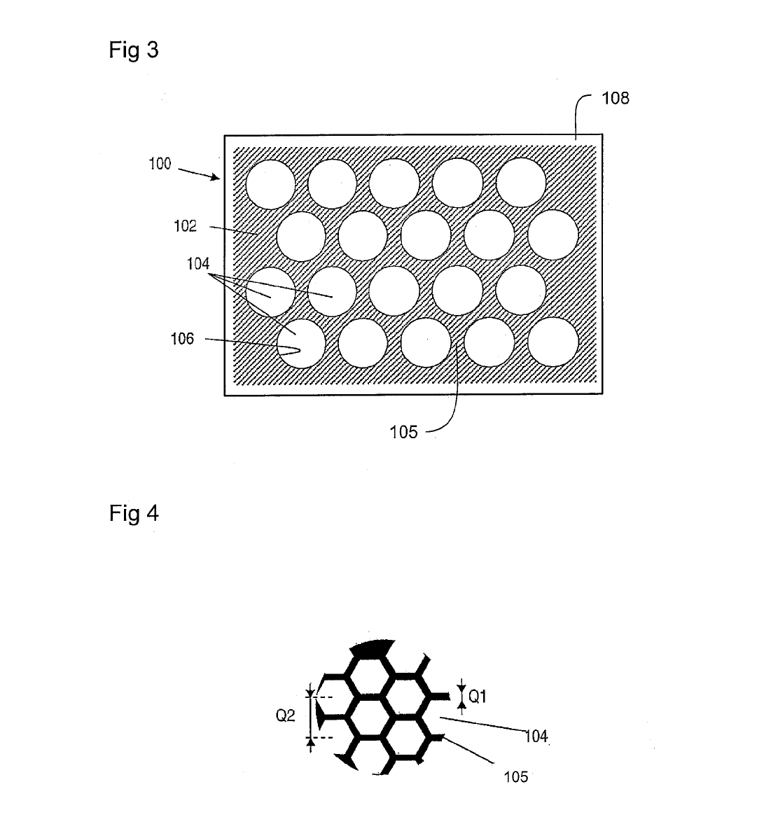

FIG. 3 is a schematic front face view of an embodiment of a spectral purity filter 100, that may for example be applied as an above-mentioned filter 11 of a lithographic apparatus. The present filter 100 is configured to transmit extreme ultraviolet (EUV) radiation. In a further embodiment, the filter 100 substantially blocks a second type of radiation generated by a radiation source, for example infrared (IR) radiation, for example infrared radiation of a wavelength larger than about 1 μm, particularly larger than about 10 μm. Particularly, the EUV radiation to be transmitted and the second type of radiation (to be blocked) can emanate from the same radiation source, for example an LPP source SO of a lithographic apparatus.

The spectral purity filter 100 in the embodiments to be described comprises a substantially planar filter part 102 (for example a filter film or filter layer) in a first region of the spectral purity filter. The filter part 102 as such can be called a ‘filter substrate’. The filter part 102 has a plurality of (preferably parallel) apertures 104 to transmit the extreme ultraviolet radiation and to suppress transmission of the second type of radiation. The face on which radiation impinges from the source SO may be referred to as the front face, while the face from which radiation exits to the illumination system IL may be referred to as the rear face. As is mentioned above, for example, the EUV radiation can be transmitted by the spectral purity filter without changing the direction of the radiation. In an embodiment, each aperture 104 has parallel sidewalls defining the apertures 104 and extending completely from the front to the rear face.

The spectral purity filter 100 may include a support frame 108 in a second region of the spectral purity filter that is adjacent the first region. The support frame 108 may be configured to provide structural support for the filter part 102. The support frame 108 may include members for mounting the spectral purity filter 100 to an apparatus in which it is to be used. In a particular arrangement, the support frame 108 may surround the filter part 100.

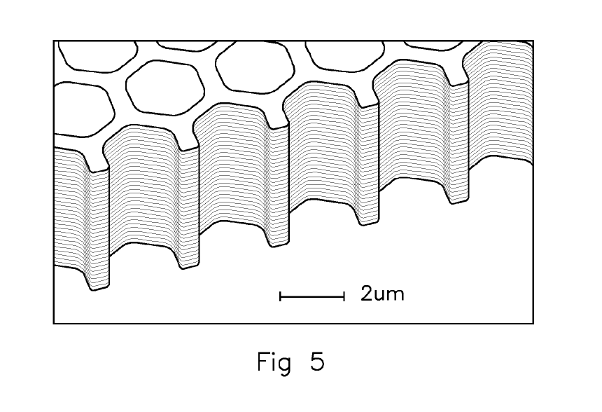

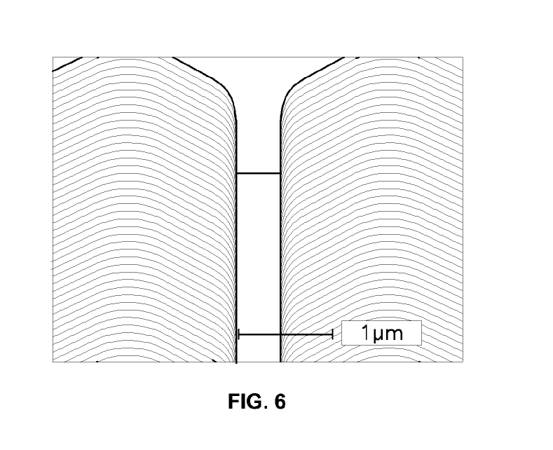

The filter 100 may include a freestanding thin film of Silicon (Si) 102 and an array of apertures 104 with substantially vertical (i.e. perpendicular to the film surface) sidewalls 106. The diameter of the apertures 104 is desirably larger than about 100 nm and more desirably larger than about 1 μm in order to allow EUV radiation to pass through the spectral purity filter 100 without substantial diffraction. Although the apertures 104 are shown schematically as having a circular cross section (in FIG. 3), other shapes are also possible, and can be preferred. For example, hexagonal apertures, as shown in FIGS. 4, 5 and 6 may be advantageous from the point of view of mechanical stability. A wavelength to be suppressed by the filter 100 can be at least 10× the EUV wavelength to be transmitted. Particularly, the filter 100 may be configured to suppress transmission of DUV radiation (having a wavelength in the range of about 100-400 nm), and/or infrared radiation having a wavelength larger than 1 μum (for example in the range of 1-11 microns).

According to an embodiment of the invention, manufacture of the spectral purity filter 100 may include an anisotropic etching method, of which a suitable example is the technique of deep reactive ion etching (DRIE), described briefly below. DRIE is an etching method with highly anisotropic etch rates, which enables the manufacturing of vertical etch profiles in Si using the so-called Bosch process. This is described for example in S. Tachi, K. Tsujimoto, S. Okudaira, Low-temperature reactive ion etching and microwave plasma etching of silicon, Appl. Phys. Lett. 52 (1988), 616. The Bosch process consists of alternately exposing the Si surface to an SF₆ plasma and a fluorocarbon (e.g. C₄F₈) plasma. In the first stage, silicon is etched in a more or less isotropic way, whereas in the second stage, the etched profile is covered by a passivation layer. In the next etch, this passivation layer is opened preferentially at the bottom, mainly by ion bombardment, and etching starts again. By repetition of the etch/passivation cycle, the etch proceeds layer by layer downwards into the silicon surface, without lateral spreading.

According to an embodiment, EUV radiation is directly transmitted through the apertures 104, preferably utilizing a relatively thin filter 100, in order to keep the aspect ratio of the apertures low enough to allow EUV transmission with a significant angular spread. The thickness of the filter part 102 (i.e. the length of each of the apertures 104) is, for example, smaller than about 20 μm, for example in the range of about 2 μm to about 10 μm, for example the range of about 5 μm to about 10 μm. Also, according to an embodiment, each of the apertures 104 may have a diameter in the range of about 100 nm to about 10 μm. The apertures 104 may, for example, each have diameter in the range of about 1.5 μm to about 6 μm, for example the range of about 2 μm to about 4 μm.

The thickness Q1 of the walls 105 between the filter apertures 104 may be smaller than 1 μm, for example in the range of about 0.4 μm to about 0.6 μm, particularly about 0.5 μm. In general, the aspect ratio of the apertures, namely the ratio of the filter part 102 to the thickness of the walls between the filter apertures 104, may be in the range of from 5:1 to 20:1. The apertures of the EUV transmissive filter 100 may have a period Q2 (indicated in FIG. 4) of in the range of about 3 μm to about 6 μm, particularly about 3 μm to about 4 μm, for example about 4 μm. Consequently, the apertures may provide an open area of about 70-80% of a total filter front surface.

The filter 100 may be configured to provide at most 5% infrared light (IR) transmission. Also, the filter 100 may be configured to transmit at least 60% of incoming EUV radiation at a normal incidence. Furthermore, the filter 100 may provide at least about 40% of transmission of EUV radiation having an angle of incidence (with respect of a normal direction) of about 10°.

In previously known methods for forming spectral purity filters as above, it has proven difficult to provide a simple manufacturing method that provides the desired accuracy of formation of features, for example the high aspect ratio of the apertures 104. In particular it has been desirable to form the high aspect ratio features, such as the walls 105 between adjacent apertures 104 from thin layers of silicon but additional processing steps have been used to protect the features thus formed from subsequent etching steps necessary to remove bulk material used to support the thin silicon layer during manufacturing.

According to an embodiment of the present invention, a new method of manufacturing a spectral purity filter as above is provided in which the desired features of the spectral purity filter, such as a the apertures 104 of the spectral purity filter 100 are formed within abase material, such as monocrystaline silicon that is selected to enable the formation of, for example, high aspect ratio features. The surfaces of the features thus formed are then chemically treated in order to convert at least the exposed layer of the base material into a different material that has a greater resistance to chemical etching than the untreated base material. In subsequent processes to remove undesired material, chemical etching may proceed without providing additional protection for the features of the spectral purity filter.

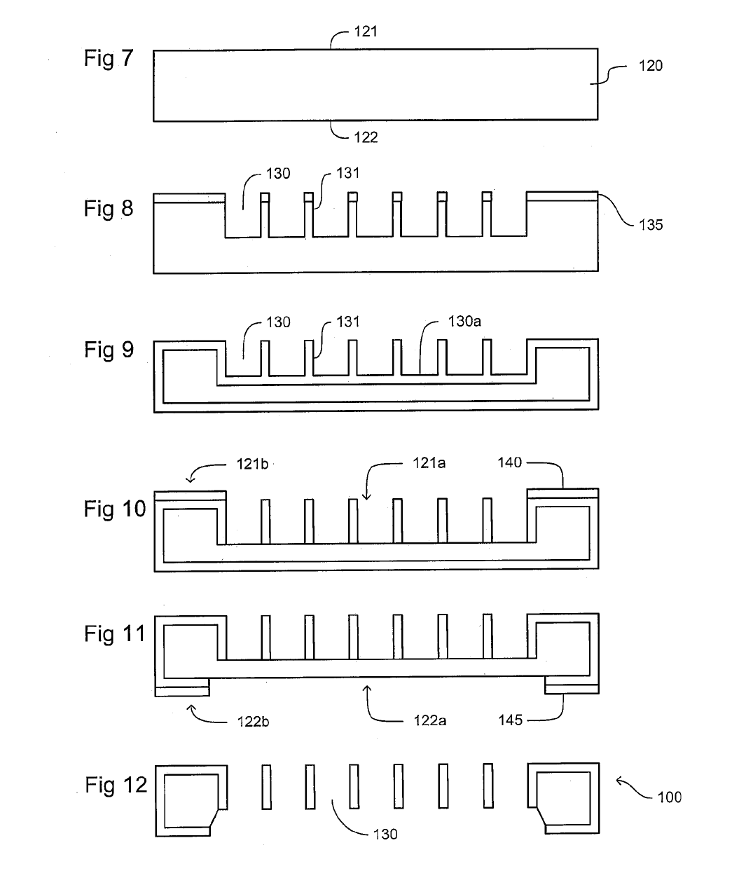

FIGS. 7 to 12 depict stages in the manufacture of a spectral purity filter according to an embodiment of the present invention.

As shown, the process may commence with a section of the base material 120, having first and second major surfaces 121,122. Openings 130 may then be formed within the first surface 121 of the base material 120 that correspond to the required apertures 104 of the spectral purity filter. In particular, the openings 130 in the first surface 121 of the base material 120 may have substantially the same width as the desired width of the apertures 104 of the spectral purity filter 100.

As shown in FIG. 8, the openings 130 in the first surface 121 of the base material 120 do not penetrate through the base material to the second surface 122. The depth of the openings 130 may substantially correspond to the thickness of the filter part 102 of the spectral purity filter 100.

Between the openings 130, walls 131 of the base material 120 remain that correspond to the desired walls 105 between the apertures 104 of the spectral purity filter. Therefore, the remaining walls 131 of the base material 120 may have substantially the same width as the walls 105 between the apertures 104 of the spectral purity filter.

The openings 130 in the first surface 121 of the base material 120 may be formed, for example, by forming a mask pattern 135, for example by a lithographic process, on the portions of the first surface 121 of the base material at which the openings 130 are not to be formed and subsequently etching the exposed base material 120. For example, deep reactive-ion etching, as discussed above may be used. Once the openings 130 are formed, the remaining mask material 135 may be removed.

As depicted in FIG. 9, once the openings 130 have been formed, at least the walls 131 separating the openings 130 may be chemically treated in order to convert the base material to a second material that is different from the base material and has a greater resistance to an etching process than the base material. It will be appreciated that the selection of the chemical treatment will depend on the etching process to be subsequently used.

In an example, a nitriding process may be used in which the silicon of the base material 120 is converted to silicon nitride. Alternatively, the chemical treatment process may include carbiding, sulphiding or oxidizing such that the base material is converted so silicon carbide, silicon sulfide or an oxide of silicon, respectively. In an example, plasma-enhanced nitridation can be used to convert the silicon into nitride up to a substantial layer thickness.

It will be appreciated that, depending on the thickness of the layer of chemically treated base material 120, substantially all of the base material in the walls 131 between the openings 130 may be converted to the second material. Alternatively, a core of the base material 120 may remain at the center of the walls 131. It will also be appreciated that, as depicted in FIG. 9, in addition to the chemical treatment being applied to the walls 130 between the openings 130 in the first surface 121 of the base material 120, the chemical treatment may be applied to substantially all of the external surfaces of the base material 120.

As shown in FIG. 10, if the bottom surface 130a of the openings 130, namely the end surface of the openings 130 that is furthest away from the first surface 121 of the base material 120, has been chemically treated to convert the base material 120 to the second material, the section of the second material at the base 130a of the openings 130 may be removed.

For example, the portions of the second material to be retained may be protected with a mask layer 140 and the material at the base 130a of the openings 130 may be removed by etching. For example, a reactive-ion etching process may be used. In particular, as shown in FIG. 10, the openings 130 may be formed within a first region 121a of the first surface 121 of the base material 120 and a second region 121b, adjacent to the first region 121 may be retained in order to form the support frame 108 as discussed above. Accordingly, the mask layer 140 may be provided on the second region 121b of the first surface 121 of the base material 120.

Subsequently, a second mask layer 145 may be provided on a region 122b of the second surface 122 of the base material 120, that corresponds to the second region 12 lb of the first surface 121, namely the portion of the second surface 122 that is to form the support frame 108 of the spectral purity filter.

An etching process, such as reactive-ion etching may be used to remove the layer of the second material from a region 122a of the second surface 122 of the base material 120 that corresponds to the region of the spectral purity filter 100 in which the apertures 104 are to be formed. As shown in FIG. 11, the region 122a in which the second material layer is removed may be slightly larger than the first region 121a of the first surface 121 of the base material 120 in which the openings 130 are formed (and correspondingly, the region 122b of the second surface protected by the mask layer 145 may be smaller than the size of the second region 121b of the first surface 121 of the base material 120) if the subsequent etching step, described below, creates slanted walls instead of vertical walls, as shown in FIG. 12. For example, in an anisotropic etching process, the 111-planes of silicon may be etched much more slowly than other directions, such that the etching process effectively stops at these (slanted) planes.

As shown in FIG. 12, the base material 120 may subsequently be removed from the region 122a of the second surface 122 corresponding to the region in which the apertures 104 are to be formed such that all of the base material 120 is removed from below the corresponding openings 130. Accordingly, the base material in the region of the openings is reduced in thickness until the openings pass through from the first side of the spectral purity filter 100 to the second side of the spectral purity filter 100.

In particular, as depicted in FIG. 12, the base material 120 may be removed from the second side 122 by means of chemical etching. For example, a potassium hydroxide (KOH) solution TMAH (Tetranethylammonium hydroxide) may be used. Vapour phase etching, plasma etching or sputtering may also be used.

It should also be appreciated that, if desired, the etching process may alternatively or additionally be performed from the first side 121 of the base material 120, namely etching the material at the base 130a of the openings 130.

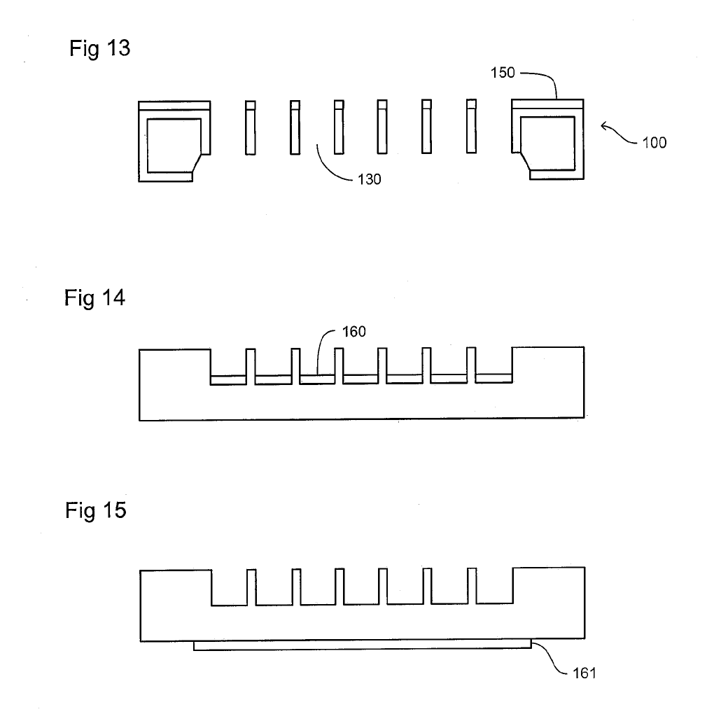

As depicted in FIG. 13, optionally an additional layer 150 of material may be formed on a surface of the spectral purity filter 100 in order to improve the reflectivity of the spectral purity filter 100 to the radiation of the second type, for which transmission is to be minimized. For example, as depicted in FIG. 13, the additional layer of material 150 may be formed on the remaining parts of the first surface 121 of the base material 120 which, as above, may have been converted to the second material. For example, a metal layer may be provided in order to improve the reflectivity of infrared radiation.

In addition to methods such as the above providing a relatively simple procedure for manufacturing a spectral purity filter 100 having the desired specifications, the provision of a spectral purity filter in which the walls of the grid structure between the apertures 104 are formed from a material other than silicon, may provide additional advantages. For example, if the walls of the grid structure are formed from silicon nitride, as per the example above, this is expected to be more stable for the environmental conditions that may be expected within a high-power EUV source. In particular, this material may be more stable than silicon at the relatively high temperatures and relatively high hydrogen radical concentration than may be expected, as discussed above. Furthermore, where a metal coating is applied to the walls 105 between the apertures 104 of a spectral purity filter 100 and the walls are formed from silicon, silicidation of the reflective metal coating may occur. However, if the walls are formed from silicon nitride, as per the example above, this may not occur. Furthermore, silicon nitride has a significantly higher emissivity in the near-infrared range than silicon (0.9 to 0.95 compared to 0.1 to 0.7, depending on the doping level and temperature). Accordingly, the coating of silicon nitride on the second surface 122b of the spectral purity filter 100 may increase the effective emissivity, leading to a lower operating temperature.

It will be appreciated that variations of the above described method for forming the spectral purity filter 100 may be used. For example, imprint lithography may be used to form the openings 130 in the first surface 121 of the base material 120. Alternatively or additionally, additional processing steps may also be used.

For example, as shown in FIG. 14, once the openings 130 have been formed in the first surface 121 of the base material 120, a mask layer 160 may be provided in the base 130a of the openings 130 prior to the step of chemically treating the surface of the base material 120. This may prevent the conversion of the base material 120 to the second material, such as silicon nitride, in this region. Subsequently, the step of etching the second material from the base 130a of the openings 130 may be obviated.

Alternatively or additionally, as depicted in FIG. 15, a mask layer 161 may be provided to the region 122a of the second surface 122 of the base material 120 corresponding to the region in which the openings 130 are formed in the first surface 121 of the base material 120 prior to the step of chemically treating the base material 120 in order to covert it into the second material. As with the variation depicted in FIG. 14, this may obviate the requirement for a step of etching the second material in the region 122a prior to the step of chemically etching the base material from the second surface 122, as depicted in FIG. 12.

It will be understood that the apparatus of FIGS. 1 and 2 incorporating the spectral purity filter may be used in a lithographic manufacturing process. Such lithographic apparatus may be used in the manufacture of ICs, integrated optical systems, guidance and detection patterns for magnetic domain memories, flat-panel displays, liquid crystal displays (LCDs), thin-film magnetic heads, etc. It should be appreciated that, in the context of such alternative applications, any use of the term “wafer” or “die” herein may be considered as synonymous with the more general term “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The descriptions above are intended to be illustrative, not limiting. Thus, it should be appreciated that modifications may be made to the present invention as described without departing from the scope of the claims set out below.

It will be appreciated that embodiments of the invention may be used for any type of EUV source, including but not limited to a discharge produced plasma source (DPP source), or a laser produced plasma source (LPP source). However, an embodiment of the invention may be particularly suited to suppress radiation from a laser source, which typically forms part of a laser produced plasma source. This is because such a plasma source often outputs secondary radiation arising from the laser.

The spectral purity filter may be located practically anywhere in the radiation path. In an embodiment, the spectral purity filter is located in a region that receives EUV containing radiation from the EUV radiation source and delivers the EUV radiation to a suitable downstream EUV radiation optical system, wherein the radiation from the EUV radiation source is arranged to pass through the spectral purity filter prior to entering the optical system. In an embodiment, the spectral purity filter is in the EUV radiation source. In an embodiment, the spectral purity filter is in the EUV lithographic apparatus, such as in the illumination system or in the projection system. In an embodiment, the spectral purity filter is located in a radiation path after the plasma but before the collector.

While specific embodiments of the present invention have been described above, it should be appreciated that the present invention may be practiced otherwise than as described.

1. A method of manufacturing a spectral purity filter having a plurality of apertures configured to transmit extreme ultraviolet radiation and to suppress transmission of a second type of radiation, the method comprising:
providing a base material having first and second major surfaces;
forming openings in the first surface of said base material corresponding to the plurality of apertures of the spectral purity filter;
chemically treating at least the surfaces of the base material surrounding the openings in the first surface to form a layer of a second material, different from the base material and which has greater resistance to an etching process than untreated base material; and
etching the base material using said etching process in order to reduce the thickness of the base material at least in the region of the openings such that the openings extend through the base material.

2. A method of manufacturing a spectral purity filter according to claim 1, the base material being monocrystalline silicon, wherein said chemically treating the surfaces of the base material comprises one of: nitriding, carbiding, sulfiding, and oxidizing, such that the resulting second material is a silicon compound comprising one of: silicon nitride, silicon carbide, silicon sulfide, and an oxide of silicon.

3. A method of manufacturing a spectral purity filter according to claim 1, wherein the base material is etched from a first region of the base material in order to reduce its thickness such that the openings extend through the base material, and wherein the base material is not etched from a second region of the base material, the second region being selected such that the underlying base material functions as a structural support for the spectral purity filter.

4. A method of manufacturing a spectral purity filter according to claim 3, further comprising: selectively removing any of the second material formed on an end surface of the openings that is furthest away from the first surface, said selectively removing the second material from the end surface of the openings optionally comprising reactive-ion etching, wherein before performing said selectively removing the second material from the end surface of the openings, a mask layer is provided to the second region of the first surface of the base material.

5. A method of manufacturing a spectral purity filter according to claim 3, further comprising selectively removing a layer of the second material from the first region of the second surface of the base material before said etching the base material in order to reduce its thickness.

6. A method of manufacturing a spectral purity filter according to claim 5, wherein the step of selectively removing the layer of the second material from the first region of the second surface comprises reactive-ion etching.

7. A method of manufacturing a spectral purity filter according to claim 5, wherein before performing said selectively removing the layer of the second material from the first region of the second surface, a mask layer is provided to the second region of the second surface of the base material.

8. A spectral purity filter comprising a grid having a plurality of apertures configured to transmit extreme ultraviolet radiation and to suppress transmission of a second type of radiation, the grid further comprising walls separating the apertures from each other, wherein the walls are substantially formed from a silicon compound.

9. A spectral purity filter according to claim 8, wherein the silicon compound is selected from the group consisting of: silicon nitride, silicon carbide, silicon sulfide, and silicon oxide.

10. A spectral purity filter manufactured by a method according to claim 1.

11. (canceled)

12. (canceled)

13. A radiation source comprising:
a spectral purity filter comprising
a grid comprising a plurality of apertures configured to transmit extreme ultraviolet radiation and to suppress transmission of a second type of radiation, and
walls separating the apertures from each other, wherein the walls are substantially formed from a silicon compound.

14. A lithographic apparatus comprising:
a radiation source configured to generate radiation comprising extreme ultraviolet radiation and a second type of radiation;
a spectral purity filter configured to transmit the extreme ultraviolet radiation and to suppress transmission of the second type of radiation, the spectral purity filter comprising
a grid comprising a plurality of apertures configured to transmit the extreme ultraviolet radiation and to suppress transmission of the second type of radiation, and
walls separating the apertures from each other, wherein the walls are substantially formed from a silicon compound;
a support configured to support a patterning device, the patterning device being configured to pattern the extreme ultraviolet radiation transmitted by the grid; and
a projection system configured to project the patterned radiation onto a substrate.
